(19) United States
(12) Patent Application Publication
(10) Pub. No.: US 2003/0130451 A1
(43) Pub. Date: Jul. 10, 2003

(54) Vanadium-imidoaryl complexes for the polymerization of olefins

(76) Inventors: Michael Arndt-Rosenau, Dormagen (DE); Martin Hoch, Heinsberg (DE); Jorg Sundermeyer, Marburg (DE); Jennifer Kipke, Mannheim (DE); Xiaoyan Li, Jinan (CN)

Correspondence Address: BAYER CORPORATION, 100 BAYER ROAD, PITTSBURGH, PA, 15205, US

(21) Appl. No.: 10/216,574

(22) Filed: Aug. 9, 2002

(30) Foreign Application Priority Data
Aug. 16, 2001 (DE) 10140135.3

(51) Int. Cl. C08F 4/06; C08F 4/44; B01J 31/00; C07F 9/00

(52) U.S. Cl. 526/161; 526/172; 502/150; 502/152; 502/155; 556/42

(57) ABSTRACT

The present invention relates to vanadium-imidoaryl compounds having electron-withdrawing substituents at the aryl group, to compositions containing vanadium-imidoaryl compounds having electron-withdrawing substituents at the aryl group, which compositions are suitable especially as catalysts for the polymerization of olefins, such as for ethene/propene or ethene/α-olefin copolymerization and the terpolymerization of those monomers with dienes.

### FIELD OF THE INVENTION

The present invention relates to vanadium-imidoaryl compounds having electron-withdrawing substituents at the aryl group, and to compositions containing vanadium-imidoaryl compounds having electron-withdrawing substituents at the aryl group. The present invention is also directed to catalysts for the polymerization of olefins, such as for ethene/propene or ethene/α-olefin copolymerization and the terpolymerization of those monomers with dienes.

### BACKGROUND OF THE INVENTION

EP-A2-0 518 415 describes vanadium-imidoaryl complexes and their use in the preparation of EPDM, wherein an improved incorporation of diene is achieved in comparison with catalysts based on VOCl₃. However, those catalysts exhibit markedly lower activities in comparison with VOCl₃.

EP-A1-0 532 098 describes vanadium-imidoaryl complexes which are substituted in the ortho-positions of the aryl group, and their use as catalysts for the polymerization of olefins at low Al/V ratios. Alkyl sub-stituents are described as particularly advantageous. At high Al/V ratios, identical products having slightly diminished catalytic activities are obtained in comparison with catalysts based on VOCl₃.

WO-94/14854-A1 describes vanadium-imidoarylamides as catalysts having high activity for the preparation of EPDM, a dialkyl-substituted aryl group again preferably being used in the imide.

### SUMMARY OF THE INVENTION

Surprisingly, it has been found that electron-withdrawing substituents at the aryl group of vanadium-imidoaryl complexes result in catalysts having markedly increased activities in comparison with o,o′-dialkyl-substituted vanadium-imidoaryls. Highly active catalysts permit the preparation of polymers with lower catalyst residues, and costly washing and purification steps can thus be avoided.

The present invention provides vanadium-imidoaryl compounds having electron-withdrawing substituents at the aryl group.

### DETAILED DESCRIPTION OF THE INVENTION

Preferred vanadium-imidoaryl compounds having electron-withdrawing substituents at the aryl group correspond to the general formula

R—N═VCl₃ (I)

or

R—N═VXYZ (II),

wherein R represents an aryl group carrying one or more electron-withdrawing substituents,

wherein X,Y,Z are each independently different or identical monoanionic ligands which may be bonded to one another and/or to the aryl group of the imide, or its substituents.

The aryl group R is distinguished by the fact that it carries one or more electron-withdrawing substituents. Of course, the aryl group may carry further substituents in addition to those substituents. R is preferably a C₆-C₁₄-aryl group.

C₆-C₁₄-aryl is to be understood as meaning all mono- or poly-nuclear aryl radicals having from 6 to 14 carbon atoms that are known to the person skilled in the art, such as phenyl, naphthyl, fluorenyl, the aryl group can, moreover, carry further substituents. Suitable substituents include hydrogen, halogen, nitro, C₁-C₁₀-alkoxy or C₁-C₁₀-alkyl, as well as C₆-C₁₄-cycloalkyl or C₆-C₁₄-aryl, such as bromophenyl, chlorophenyl, toloyl and nitrophenyl.

C₁-C₁₀-alkoxy is to be understood as meaning all linear or branched alkoxy radicals having from 1 to 10 carbon atoms that are known to the person skilled in the art, such as methoxy, ethoxy, n-propoxy, isopropoxy, n-butoxy, isobutoxy, tert-butoxy, n-pentoxy, isopentoxy, neopentoxy and hexyloxy, heptyloxy, octyloxyl, nonyloxy and decyloxy, which radicals may in turn be substituted.

C₁-C₁₀-alkyl is to be understood as meaning all linear or branched alkyl radicals having from 1 to 10 carbon atoms that are known to the person skilled in the art, such as methyl, ethyl, n-propyl, isopropyl, n-butyl, isobutyl, tert-butyl, n-pentyl, isopentyl, neopentyl and hexyl, heptyl, octyl, nonyl and decyl, which radicals may in turn be substituted. Suitable substituents include hydrogen, halogen, nitro, hydroxyl or C₁-C₁₀-alkyl, as well as C₆-C₁₄-cycloalkyl or C₆-C₁₄-aryl, such as benzoyl, trimethylphenyl, ethylphenyl, chloromethyl, chloroethyl and nitromethyl.

C₆-C₁₄-cycloalkyl is to be understood as meaning all mono- or poly-nuclear cycloalkyl radicals having from 6 to 14 carbon atoms that are known to the person skilled in the art, such as cyclohexyl, cycloheptyl, cyclooctyl and cyclononyl, or partially or completely hydrogenated fluorenyl, which radicals may in turn be substituted. Suitable substituents include hydrogen, halogen, nitro, C₁-C₁₀-alkoxy or C₁-C₁₀-alkyl, as well as C₆-C₁₂-cycloalkyl or C₆-C₁₂-aryl, such as methylcyclohexyl, chlorocyclohexyl and nitrocyclohexyl.

Suitable electron-withdrawing substituents include all groups known to the person skilled in the art that lower the electron density of the aryl group, such as halogen, halogenated alkyl, nitro, cyano, carbonyl and carboxyl groups.

Halogen groups and perhalogenated alkyl groups are preferably used as electron-withdrawing substituents. Chlorine, bromine and iodine substituents are more preferred.

Preference is given to compounds that carry the electron-withdrawing substituents in the ortho- and/or para-position relative to the imido group. More preference is given to o,o- and o,o,p-substituted aryl groups.

As already mentioned, the monoanionic ligands may also be bonded in the form of chelating ligands to one another and/or to the imide.

It is also possible to introduce further neutral ligands, such as, for example, tetrahydrofuran, 1,2-dimethoxyethane, phosphines, diphosphines, imines, diimines, into the ligand structure of the vanadium-imidoaryl compound. Such compounds containing neutral ligands are expressly included in the present invention.

Preferred monoanionic ligands include halogen, C₁-C₁₀-alkoxy, C₆-C₁₄-aryloxy and amido groups. Halogen and C₁-C₁₄-aryloxy groups are more preferred.

Preferred structures of the vanadium-imidoaryl compounds according to the present invention having electron-withdrawing substituents at the aryl group include:

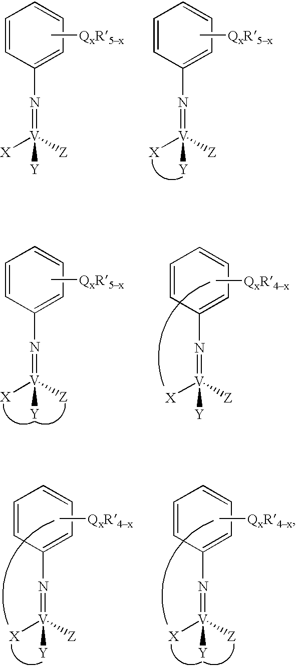

wherein Q represents said electron-withdrawing group(s) and R′ represents further substituents of the aryl group which, as already mentioned, are selected from the group consisting of hydrogen, halogen, nitro, C₁-C₁₀-alkoxy and C₁-C₁₀-alkyl, as well as C₆-C₁₄-cycloalkyl and C₆-C₁₄-aryl.

The present invention also provides compositions containing vanadium-imidoaryl compounds having electron-withdrawing substituents at the aryl group, and an organometallic compound of Group 1, 2, 12 or 13 of the periodic system of the elements according to IUPAC 1985, at least one hydrocarbon group being bonded directly to the metal atom via a carbon atom.

Preferred organometallic compounds include compounds of aluminum, sodium, lithium, zinc and magnesium. Compounds of aluminum are more preferred.

The hydrocarbon group bonded to the metal atom is preferably a C₁-C₁₀-alkyl group. Examples include amylsodium, butyllithium, diethylzinc, butylmagnesium chloride, dibutylmagnesium. Suitable aluminum compounds include trialkylaluminum compounds, alkylaluminium hydrides, such as, for example, diisobutylaluminum hydride, alkylalkoxyaluminum compounds, alkylaryloxyaluminum compounds, aluminoxanes and halogen-containing aluminum compounds, such as, for example, diethylaluminum chloride, diisobutylaluminum chloride, ethylaluminum chloride or ethylaluminum sesquichloride. It is also possible to use mixtures of those components.

The molar ratio between the organometallic compound and the vanadium can be varied within wide limits. In general, it will vary in the range from 1:1 to 5000:1. The range from 1:1 to 500:1 is preferred. The range from 2:1 to 100:1 is more preferred.

The composition of the present invention is suitable as a catalyst. The compound of the present invention is suitable as a catalyst for the polymerization of olefins, especially for ethene/propene or ethene/α-olefin copolymerization and the terpolymerization of those monomers with dienes.

The catalyst of the present invention can be modified by additives known to the person skilled in the art that increase the productivity of the catalyst and/or alter the properties of the resulting polymer.

Activity-increasing additives include halogen-containing compounds, preferably halogen-containing hydrocarbons. Said hydrocarbons can contain further atoms, such as oxygen, nitrogen, phosphorus and sulfur. More preference is given to compounds that contain only a little halogen (from 1 to 2 atoms per molecule), therby keeping the halogen concentration in the polymer kept low. Alkyl and alkoxyalkyl esters of phenyl-mono- and -di-chloroacetic acid as well as diphenyl chloro acetic acid are most preferred.

Further suitable activity-increasing additives include Lewis acids, such as, for example, AlCl₃, BCl₃ or SiCl₄, or Lewis bases, such as esters, amines, ammonia, ketones, alcohols, ethers.

Express mention is also made of mixtures of the mentioned activity-increasing additives.

It may be advantageous to apply the catalyst system according to the present invention to a support.

There are used as support materials particulate, organic or inorganic solids whose pore volume is from 0.1 to 15 ml/g, preferably from 0.25 to 5 ml/g, whose specific surface area is greater than 1 m²/g, preferably from 10 to 1000 m²/g (BET), whose particle size is from 10 to 2500 μm, preferably from 50 to 1000 μm, and which can be suitably modified at their surface.

The specific surface area is determined in the conventional manner according to DIN 66 131, the pore volume is determined by the centrifugation method according to McDaniel, J. Colloid Interface Sci. 1980, 78, 31, and the particle size is determined according to Cornillaut, Appl. Opt. 1972, 11, 265.

The following may be mentioned as examples of suitable inorganic solids: silica gels, precipitated silicas, clays, alumosilicates, talcum, zeolites, carbon black, inorganic oxides, such as, for example, silicon dioxide, aluminum oxide, magnesium oxide, titanium dioxide, inorganic chlorides, such as, for example, magnesium chloride, sodium chloride, lithium chloride, calcium chloride, zinc chloride, or calcium carbonate. The mentioned inorganic solids, which meet the above-mentioned specification and therefore are particularly suitable for use as support materials, are described in greater detail, for example, in Ullmanns Enzyklopädie der technischen Chemie, Volume 21, p.439 et seq (silica gels), Volume 23, p. 311 et seq (clays), Volume 14, p. 633 et seq (carbon blacks) and Volume 24, p. 575 et seq (zeolites).

Organic solids include suitable powdered, polymeric materials, preferably in the form of free-flowing powders, having the above-mentioned properties. There may be mentioned by way of example, without limiting the present invention: polyolefins, such as, for example, polyethene, polypropene, polystyrene, polystyrene-co-divinylbenzene, polybutadiene, polyethers, such as, for example, polyethylene oxide, polyoxytetramethylene, or polysulfides, such as, for example, poly-p-phenylene sulfide. Particularly suitable materials are polypropylene, polystyrene or polystyrene-co-divinylbenzene. The mentioned organic solids, which meet the above-mentioned specification and therefore are particularly suitable for use as support materials, are described in greater detail, for example, in Ullmanns Enzyklopädie der technischen Chemie, Volume 19, p.195 et seq (polypropylene) and Volume 19, p. 265 et seq (polystyrene).

The preparation of the supported catalyst system can take place in a wide temperature range. In general, the temperature is between the melting point and the boiling point of the inert solvent mixture. The reaction is usually carried out at temperatures of from −50 to +200° C., preferably from −20 to 100° C., more preferably from 20 to 60° C.

The present invention also relates to a process for the homo- or co-polymerization of olefins, preferably ethene, propene, isobutene, 1-butene, 2-butene, 1-hexene, 1-octene, 4-methyl-1-pentene, unsaturated alicyclic compounds such as, for example, cyclopentene, norbornene, and to a process for the copolymerization of those monomers with one or more dienes, preferably ethylidene norbornene, vinyl norbornene, dicyclo-pentadiene, 1,4-hexadiene. The invention relates further to a process for the homo- or co-polymerization of conjugated dienes such as butadiene and isoprene and their copolymerization with olefins, alicyclic olefins, styrene and styrene derivatives, as well as polar vinyl monomers, such as, for example, acrylonitrile, methyl acrylate, butyl acrylate, methyl methacrylate.

The polymerization is preferably carried out by bringing the olefins into contact with the catalyst system according to the present invention in solution in suitable solvents, in gaseous form, in finely distributed liquid form or in suspension in a liquid diluent. The catalysts are generally used in amounts in the range from 10⁻¹⁰ to 10⁻¹ mol % per mole of monomer.

It is possible to mix with the gaseous, liquid or atomized monomers further gases or finely divided liquids, which serve either for dilution, for atomization or for the dissipation of heat.

The examples, which follow, are intended to illustrate the present invention and the implementation of homo- and co-polymerization processes catalyzed therewith.

### EXAMPLES

All the syntheses listed hereinbelow were carried out under an Ar atmosphere.

Unless described otherwise, all the chemicals used are commercial products from Acros, Aldrich, Avocado, Fluka or Merck-Schuchardt. Dichlorophenylacetic acid ester was synthesized as specified in the literature (EP 75 355, page 3, Example II).

### Example 1

Synthesis of (2,6-iPr₂Ph)-N═V—O-(2,6-iPr₂Ph)Cl₂ (Comparative Example)

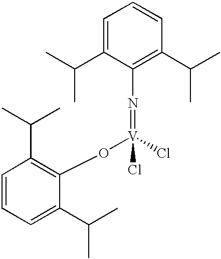

(2,6-iPr₂Ph)-N═VCl₃ is prepared as followed. At room temperature a solution of 9.13 g (52.70 mmol) VOCl₃ in 20 ml of n-octane is added dropwise to a soltution of 12.95 g (57.95 mmol) 2,6-diisopropyl-phenyl-sulfinylamine in 40 ml of n-octane. The reaction mixture spontanously becomes red. After refuxing for 3 h it becomes green. After removal of volatile constituents by evaporation in vacuum the solid residue is digested two times with 20 ml of n-pentane and stored at −80° C. for 24 h each. The product is filtered off and dried in vacuum.

Yield: 16.83 g (96%)

analysis:

C: 44.84 (calc. 43.34); H: 5.47 (calc. 5.15): N: 4.50 (calc. 4.21

1H-NMR (200 MHz, C606): 1.16 (d, 12H, CH(CH₃)₂), 6.60-6.68 (m, 3H, HArom) ppm

13 C-NMR (50 MHz, C606): 24.0 (CH(CH₃)₂), 122.8 (CArom-meta), 128.5 (CArom-para), 132.7 (CArom-ortho),

151.6 (═N-CArom)ppm

51V-NMr (105 MHz, C606): 392 ppm

2,6-Diisopropylphenol (279 mg/1.565 mmol) is added dropwise at −30° C. to a solution of (2,6-iPr₂Ph)-N═VCl₃ (505 mg/1.581 mmol, 40 ml of hexane). The solution immediately turns dark-brown in colour. After 15 hours stirring at room temperature, the dark-red solution is dried in vacuum. The residue is taken up in 20 ml of pentane. At −80° C., the product precipitates in the form of a red wax. The compound is a red oil at room temperature.

Yield: 660 mg (92%)

¹H-NMR (300 MHz, CDCl₃): 1.02 (d, 12H, ³J(HH)=6.6 Hz, CH(CH₃)₂), 1.08 (d, 12H, ³J(HH)=6.90 Hz, CH(CH₃)₂), 3.19 (sep, 2H, ³J(HH)=6.90

Hz, CH(CH₃)₂), 3.62 (sep, 2H, ³J(HH)=6.90 Hz, CH(CH₃)₂), 6.86-7.64 (m, 6H, Hₐᵣₒₘ).

¹³C-NMR (75.5 MHz, CDCl₃): 22.5, 22.8 (CH(CH₃)₂), 26.4, 27.9 (CH (CH₃)₂), 121.4, 122.2, 122.4, 123.4, 125.2, 129.4, 135.5 (Cₐᵣₒₘ).

### Example 2

Synthesis of (2,6-iPr₂Ph)-N═V—O-(2,4,6-I₃Ph)Cl₂ (Comparative Example)

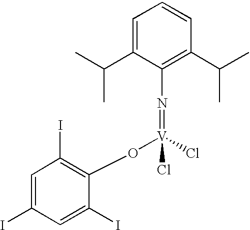

(2,6-iPr₂Ph)-N═VCl₃ is prepared as described in Example 1.

80 ml of hexane are added at −30° C. to a mixture of (2,6-iPr₂Ph)-N═VCl₃ (1.423 g/4.278 mmol) and 2,4,6-triiodophenol (2.020 g/4.278 mmol). The reaction mixture is stirred at room temperature for 15 hours. No marked change in color is observed during that time. After removal of the solvent, a dark-red residue is obtained. The residue is taken up in hexane. At −80° C., the product precipitates in the form of a dark-red solid.

Yield: 2.70 g (82%)

¹H-NMR (300 MHz, CDCl₃): 1.11 (d, 12H, ³J(HH)=6.60 Hz, CH(CH₃)₂), 3.70 (sep, 2H, ³J(HH)=6.60 Hz, CH(CH₃)₂), 6.95 (m, 3H, NAr—H), 8.03 (s, 2H, OAr—H).

### Example 3

Synthesis of (2,4,6-Cl₃Ph)-N═VCl₃

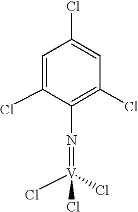

3.65 g (2 ml, 21.1 mmol) of VOCl₃ in 20 ml of toluene are added dropwise at room temperature to 6.64 g (27.4 mmol) of 2,4,6-trichlorophenyl-sulfinylamine (synthesis according to A. Meller et al., Chem. Ber. 113 (1980), 1950-1961, page 1954, method A) in 40 ml of toluene. The reaction mixture spontaneously turns dark-green in color. After 30 minutes stirring, volatile constituents are removed in vacuum, and the residue is digested three times using 20 ml of pentane each time and is stored for 24 hours at −80° C. Portions that are insoluble in pentane are filtered off, and the filtrate is concentrated to dryness in order to obtain the complex.

Yield: 6.3 g (85%)

C: 20.79 (calc. 20.49); H: 0.57 (calc. 0.63); N: 4.02 (calc. 3.98)

¹H-NMR (200 MHz, C₆D₆): 6.24 (s, 2H, Ar—Hₘₑₜₐ) ppm

¹³C-NMR (50 MHz, C₆D₆): 128.3 (Ar—Cₘₑₜₐ), 135.9, 136.7 (Ar—Cₒᵣₜₕₒ+Cₚₐᵣₐ) ppm

⁵¹V-NMR (131 MHz, C₆D₆): 276.6 ppm

IR (Nujol): 1551vs, 1522m, 1512m, 1306m, 1206m, 1190m, 1153s, 1084m, 1063w, 972w, 876w, 858s, 839w, 820s, 806m, 729w, 721w, 710w, 696w, 669w, 611w, 575w, 529w, 484w, 453s cm⁻¹

EI-MS: m/z=352 (M⁺, 12%), 196 (C₆H₂Cl₃N⁺, 100%), 158 (VCl₃⁺, 28%)

### Example 4

Synthesis of (2,4,6-Cl₃Ph)-N═V—O-(2,6-iPr₂Ph)Cl₂

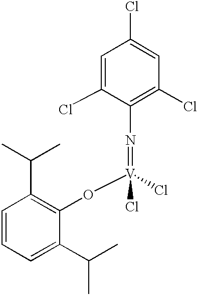

2,6-Diisopropylphenol (0.956 g/5.362 mmol) is added dropwise at −30° C. to a solution of (2,4,6-Cl₃Ph)-N═VCl₃ (1.887 g/5.367 mmol in 60 ml of hexane). The solution immediately turns dark-brown in color. After 15 hours stirring at room temperature, the dark-red solution is dried in vacuum. The residue is taken up in 20 ml of pentane. At −80° C., the product precipitates in the form of a red wax. The compound is a red oil at room temperature.

Yield: 2.41 g (91%)

¹H-NMR (300 MHz, CDCl₃): 1.10 (d, 12H, ³J(HH)=6.60 Hz, CH(CH₃)₂), 3.15 (sep, 2H, ³J(HH)=6.60 Hz, CH(CH₃)₂), 7.05 (m, 5H, Hₐᵣₒₘ).

### Example 5

Synthesis of (2,4,6-Cl₃Ph)-N═V—O-(2,4,6-I₃Ph)Cl₂

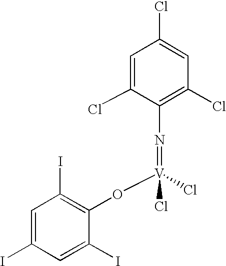

80 ml of hexane are added at −30° C. to a mixture of (2,4,6-Cl₃Ph)-N═VCl₃ (1.749 g/4.974 mmol) and 2,4,6-triiodophenol (2.340 g/4.956 mmol). The reaction mixture is stirred at room temperature for 15 hours. No marked change in color is observed during that time. After removal of the solvent, a dark-red residue is obtained. The residue is taken up in hexane. At −80° C., the product precipitates in the form of a dark-red solid.

Yield: 3.05 g (78%)

¹H-NMR (300 MHz, CDCl₃): 7.14 (m, 2H), 8.00 (m, 2H).

### Example 6

Ethene/Propene Copolymerization

The apparatus adjusted to a temperature of 40° C. with a thermostat is evacuated to 5*10⁻² for 30 minutes. Purified propene is then introduced to a pressure of 1.5 bar. 40 ml of hexane, which has been rendered absolute and 0.408 mmol (18.5 eq) of a 15% solution of ethylaluminum sesquichloride (Witco) in heptane are introduced into the autoclave in a propene countercurrent. The apparatus is then closed under a propene atmosphere in order to fill a pressure syringe with 50 ml of hexane and 0.096 mmol (4.4 eq) of dichlorophenylacetic acid ethyl ester in a propene countercurrent. 0.022 mmol (1.0 eq) of the vanadium precursor compound dissolved in 30 ml of hexane is then introduced into a stirrer vessel. The hexane solution is saturated for 15 minutes with propene at 3.7 bar. After shutting off the supply of propene, the overall pressure is adjusted to 5.5 bar with purified ethene. The reaction takes place at 40° C. and is started by injection of the reactivator using the pressure syringe. Stirring is carried out by means of an anchor stirrer under a constant ethene pressure at 5.5 bar and at 1000 rpm.

After 10 minutes, the reaction is terminated by the dropwise addition of the mixture into hydrochloric acid-containing methanol. The polymer precipitate is washed with ethanol and then dried for 10 hours at 50° C., and the yield is determined.

TABLE 1
Results of the ethene/propene copolymerization by vanadium-
imidoaryl catalysts.

| Catalyst | Yield [g] |
|---|---|
| (2,6-iPr₂Ph)-N = VCl₃ | 7.2 |
| (2,4,6-Cl₃Ph)-N = VCl₃ | 9.3 |
| (2,6-iPr₂Ph)-N = V-O-(2,6-iPr₂Ph)Cl₂ | 8.6 |
| (2,4,6-Cl₃Ph)-N = V-O-(2,6-iPr₂Ph)Cl₂ | 10.5 |
| (2,6-iPr₂Ph)-N = V-O-(2,4,6-I₃Ph)Cl₂ | 9.0 |
| (2,4,6-Cl₃Ph)-N = V-O-(2,4,6-I₃Ph)Cl₂ | 10.7 |

The tests carried out clearly show that vanadium-imidoaryl catalysts having strongly electron-withdrawing groups (in this case o,o,p-Cl) yield markedly better catalytic activities.

### Example 7

EPDM Synthesis

An autoclave which has been rendered inert is filled with 1500 ml of hexane and 6.0 g of ethylidene norbornene and heated to the polymerization temperature of 40° C. Ethene and propene are then introduced in a ratio of 1:19 to a pressure of 7 bar. The catalyst components (0.05 mmol of V component, 1 mmol of ethylaluminum sesquichloride (Witco) and 0.25 mmol of dichlorophenylacetic acid ethyl ester) are introduced into the reactor simultaneously via pressure burettes, and polymerization is then carried out at a pressure of 7.0 bar. Regulation is effected by the metered addition of ethene. After half an hour, the test is terminated and the batch is transferred to a container filled with ethanol. The polymer is dried at 80° C. in a vacuum drying cabinet.

TABLE 2
Results of the ethene/propene/ethylidene norbornene
terpolymerization by vanadium catalysts.

| | Yield | E | P | ENB | Tg | | |
|---|---|---|---|---|---|---|---|
| Catalyst | [g] | [wt. %] | [wt. %] | [wt. %] | [° C.] | M_{w} | M_{w}/Mₙ |
| O = VCl₃ | 25.9 | 46.0 | 44.2 | 9.8 | −46 | 205,000 | 2.3 |
| (2,4,6-Cl₃- | 31.3 | 48.3 | 42.0 | 9.7 | −46 | 227,000 | 1.9 |
| Ph)- | | | | | | | |
| N = VCl₃ | | | | | | | |

### Example 8

Synthesis of (2,6-iPr₂Ph)-N═V—Cl₃—Catalysts A (Comparative Example)

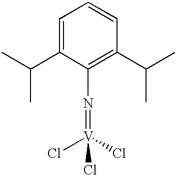

At room temperature a solution of 9.13 g (52.70 mmol) VOCl₃ in 20 ml of n-octane is added dropwise to a soltution of 12.95 g (57.95 mmol) 2,6-diisopropyl-phenyl-sulfinylamine in 40 ml of n-octane. The reaction mixture spontanously becomes red. After refuxing for 3 h it becomes green. After removal of volatile constituents by evaporation in vacuum the solid residue is digested two times with 20 ml of n-pentane and stored at −80° C. for 24 h each. The product is filtered off and dried in vacuum.

Yield: 16.83 g (96%)

analysis:

C: 44.84 (calc. 43.34); H: 5.47 (calc. 5.15): N: 4.50 (calc. 4.21 1H-NMR (200 MHz, C606): 1.16 (d, 12H, CH(CH₃)₂), 6.60-6.68 (m, 3H, HArom) ppm

13 C-NMR (50 MHz, C606): 24.0 (CH(CH₃)₂),122.8 (CArom-meta), 128.5 (CArom-para), 132.7 (CArom-ortho),

151.6 (═N—CArom)ppm

51V-NMr (105 MHz, C606): 392 ppm

### Example 9

Synthesis of (2,6-iPr₂Ph)-N═V—O-(2,6-iPr₂Ph)Cl₂—Catalysts B (Comparative Example)

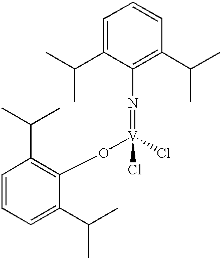

(2,6-iPr₂Ph)-N═VCl₃ is prepared as described in Example 8.

2,6-Diisopropylphenol (279 mg/1.565 mmol) is added dropwise at −30° C. to a solution of (2,6-iPr₂Ph)-N═VCl₃ (505 mg/1.581 mmol, 40 ml of hexane). The solution immediately turns dark-brown in color. After 15 hours stirring at room temperature, the dark-red solution is dried in vacuum. The residue is taken up in 20 ml of pentane. At −80° C., the product precipitates in the form of a red wax. The compound is a red oil at room temperature.

Yield: 660 mg (92%)

¹H-NMR (300 MHz, CDCl₃): 1.02 (d, 12H, ³J(HH)=6.6 Hz, CH(CH₃)₂), 1.08 (d, 12H, ³J(HH)=6.90 Hz, CH(CH₃)₂), 3.19 (sep, 2H, ³J(HH)=6.90

Hz, CH(CH₃)₂), 3.62 (sep, 2H, ³J(HH)=6.90 Hz, CH(CH₃)₂), 6.86-7.64 (m, 6H, Hₐᵣₒₘ).

¹³C-NMR (75.5 MHz, CDCl₃): 22.5, 22.8 (CH(CH₃)₂), 26.4, 27.9 (CH (CH₃)₂), 121.4, 122.2, 122.4, 123.4, 125.2, 129.4, 135.5 (Cₐᵣₒₘ).

### Example 10

Synthesis of (2,6-iPr₂Ph)-N═V—O-(2,4,6-I₃Ph)Cl₂ (Comparative Example) Catalyst C

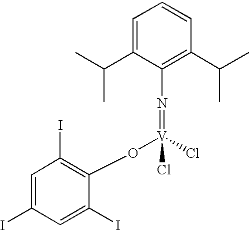

(2,6-iPr₂Ph)-N═VCl₃ is prepared as described in Example 8.

80 ml of hexane are added at −30° C. to a mixture of (2,6-iPr₂Ph)-N═VCl₃ (1.423 g/4.278 mmol) and 2,4,6-triiodophenol (2.020 g/4.278 mmol). The reaction mixture is stirred at room temperature for 15 hours. No marked change in color is observed during that time. After removal of the solvent, a dark-red residue is obtained. The residue is taken up in hexane. At −80° C., the product precipitates in the form of a dark-red solid.

Yield: 2.70 g (82%)

¹H-NMR (300 MHz, CDCl₃): 1.11 (d, 12H, ³J(HH)=6.60 Hz, CH(CH₃)₂), 3.70 (sep, 2H, ³J(HH)=6.60 Hz, CH(CH₃)₂), 6.95 (m, 3H, NAr—H), 8.03 (s, 2H, OAr—H).

### Example 11

Synthesis of (2,4,6-Cl₃Ph)-N═VCl₃—Catalyst D

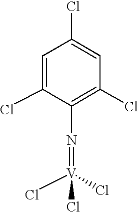

3.65 g (2 ml, 21.1 mmol) Of VOCl₃ in 20 ml of toluene are added dropwise at room temperature to 6.64 g (27.4 mmol) of 2,4,6-trichlorophenyl-sulfinylamine (synthesis according to A. Meller et al., Chem. Ber. 1 13 (1980), 1950-1961 according to page 1954, method A) in 40 ml of toluene.

To 9.82 g 2,4,6-Trichloroaniline (0.05 mol) dissolved in 20 ml benzene 11.9 g thionylchloride (0.1 mol) are added at 25° C. The reaction mixture is refluxed for 6 h. All volatile constituents are removed at 40° C./10-2 mbar. Upon cooling to room temperature the 2,4,6-trichlorophenylsulfinylamine solidifies.

The reaction mixture spontaneously turns dark-green in color. After 30 minutes stirring, volatile constituents are removed in vacuum, and the residue is digested three times using 20 ml of pentane each time and is stored for 24 hours at −80° C. Portions that are insoluble in pentane are filtered off, and the filtrate is concentrated to dryness in order to obtain the complex.

Yield: 6.3 g (85%)

C: 20.79 (calc. 20.49); H: 0.57 (calc. 0.63); N: 4.02 (calc. 3.98)

¹H-NMR (200 MHz, C₆D₆): 6.24 (s, 2H, Ar—Hₘₑₜₐ) ppm ¹³C-NMR (50 MHz, C₆D₆): 128.3 (Ar—Cₘₑₜₐ), 135.9, 136.7 (Ar—Cₒᵣₜₕₒ+Cₚₐᵣₐ) ppm

⁵¹V-NMR (131 MHz, C₆D₆): 276.6 ppm

IR (Nujol): 1551vs, 1522m, 1512m, 1306m, 1206m, 1190m, 1153s, 1084m, 1063w, 972w, 876w, 858s, 839w, 820s, 806m, 729w, 721w, 710w, 696w, 669w, 611w, 575w, 529w, 484w, 453s cm⁻¹

EI-MS: m/z=352 (M⁺, 12%), 196 (C₆H₂Cl₃N⁺, 100%), 158 (VCl₃⁺, 28%)

### Example 12

Synthesis of (2,4,6-Cl₃Ph)-N═V—O-(2,6-iPr₂Ph)Cl₂—Catalyst E

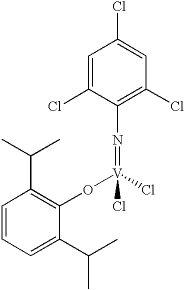

2,6-Diisopropylphenol (0.956 g/5.362 mmol) is added dropwise at −30° C. to a solution of (2,4,6-Cl₃Ph)-N═VCl₃ which is prepared as described in Example 11 (1.887 g/5.367 mmol in 60 ml of hexane). The solution immediately turns dark-brown in color. After 15 hours stirring at room temperature, the dark-red solution is dried in vacuum. The residue is taken up in 20 ml of pentane. At —80° C., the product precipitates in the form of a red wax. The compound is a red oil at room temperature.

Yield: 2.41 g (91%)

¹H-NMR (300 MHz, CDCl₃): 1.10 (d, 12H, ³J(HH)=6.60 Hz, CH(CH₃)₂), 3.15 (sep, 2H, ³J(HH)=6.60 Hz, CH(CH₃)₂), 7.05 (m, 5H, Hₐᵣₒₘ).

### Example 13

Synthesis of (2,4,6-Cl₃Ph)-N═V—O-(2,4,6-I₃Ph)Cl₂—Catalyst F

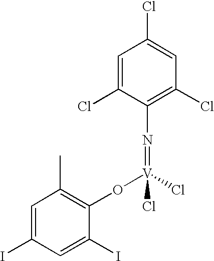

80 ml of hexane are added at −30° C. to a mixture of (2,4,6-Cl₃Ph)-N═VCl₃ which is prepared as described in Example 11 (1.749 g/4.974 mmol) and 2,4,6-triiodophenol (2.340 g/4.956 mmol). The reaction mixture is stirred at room temperature for 15 hours. No marked change in color is observed during that time. After removal of the solvent, a dark-red residue is obtained. The residue is taken up in hexane. At −80° C., the product precipitates in the form of a dark-red solid.

Yield: 3.05 g (78%)

¹H-NMR (300 MHz, CDCl₃): 7.14 (m, 2H), 8.00 (m, 2H).

### Example 14

Synthesis of (2,4,6-Br₃Ph)-N═VCl₃—Catalyst G

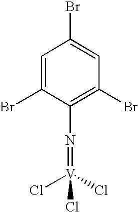

2,4,6-Tribromophenylsulfinylamine is prepared as specified in the literature (Michaelis; Humme; Chem. Ber. 24 (1891) 755, line 1; Michaelis; Humme; Justus Liebigs Ann. Chem. 274 (1893) 221 according to page 221,line 26).

To 16.49 g 2,4,6-Tribromoaniline (0.05 mol) dissolved in 20 ml benzene 11.9 g thionylchloride (0.1 mol) are added at 25° C. The reaction mixture is refluxed for 6 h. All volatile constituents are removed at 40° C./10-2 mbar. Upon cooling to room temperature the 2,4,6-tribromophenylsulfinylamine solidifies.

3 ml (31.62 mmol) VOCl₃ in 30 ml of toluene are added dropwise at room temperature to 15.03 g (39.99 mmol) 2,4,6-tribromophenylsulfinylamine in 100 ml of toluene. The reaction mixture is refluxed for 8 h. The volatile constituents are removed in vacuum, and the residue is dissolved 250 ml of n-pentane. The product precipitates as a dark green solid after storing at −78° C. over night. The product is filtered off and dried in vacuum.

Yield:13.96 g (91%).

¹H-NMR: (200 MHz, CDCl₃): 7.44 (s, 2H, Ar—H) ppm

EI-MS: m/z=485 (M⁺); 328 (C₆H₂Br₃N⁺, 16%); 248 (C₆H₂Br₂N⁺, 7%); 158 (VCl₃⁺,3%); 36 (Cl⁺, 100%)

### Example 15

Ethene/Propene Copolymerization

The apparatus adjusted to a temperature of 40° C. with a thermostat is evacuated to 5*10⁻² for 30 minutes. Purified propene is then introduced to a pressure of 1.5 bar. 40 ml of hexane, which has been rendered absolute and 0.408 mmol (18.5 eq) of a 15% solution of ethylaluminum sesquichloride (Witco) in heptane are introduced into the autoclave in a propene countercurrent. The apparatus is then closed under a propene atmosphere in order to fill a pressure syringe with 50 ml of hexane and 0.096 mmol (4.4 eq) of dichlorophenylacetic acid ethyl ester in a propene countercurrent. 0.022 mmol (1.0 eq) of the vanadium precursor compound dissolved in 30 ml of hexane is then introduced into a stirrer vessel. The hexane solution is saturated for 15 minutes with propene at 3.7 bar. After shutting off the supply of propene, the overall pressure is adjusted to 5.5 bar with purified ethene. The reaction is started at 40° C. by injection of the reactivator using the pressure syringe. Stirring is carried out by means of an anchor stirrer under a constant ethene pressure at 5.5 bar and at 1000 rpm.

After 10 minutes, the reaction is terminated by the dropwise addition of the mixture into hydrochloric acid-containing methanol. The polymer precipitate is washed with ethanol and then dried for 10 hours at 50° C., and the yield is determined.

TABLE 1
Results of the ethene/propene copolymerization by vanadium-
imidoaryl catalysts.

| Catalyst | Yield [g] |
|---|---|
| VOCl₃ | 7.2 |
| Catalysts A | 6.4 |
| Catalysts D | 8.4 |
| Catalyst G | 9.8 |

The tests carried out clearly show that vanadium-imidoaryl catalysts D and G having strongly electron-withdrawing groups (in this case o,o,p-Cl and o,o,p-Br) in contrast to those described in EP-A2-0518 415 yield markedly better catalytic activities than VOCl₃. They are also more active than vanadium-imidoaryl catalysts according to EP-A1-0532 098 and WO-94/148554-A1 carrying alkyl substituents, as shown by the comparison of the test carried out with catalysts A, D and G.

### Example 16

Ethene/Propene Copolymerization

The apparatus adjusted to a temperature of 40° C. with a thermostat is evacuated to 5*10⁻² for 30 minutes. Purified propene is then introduced to a pressure of 1.5 bar. 40 ml of hexane, which has been rendered absolute and 0.408 mmol (18.5 eq) of a 15% solution of ethylaluminum sesquichloride (Witco) in heptane are introduced into the autoclave in a propene countercurrent. The apparatus is then closed under a propene atmosphere in order to fill a pressure syringe with 50 ml of hexane and 0.096 mmol (4.4 eq) of dichlorophenylacetic acid ethyl ester in a propene countercurrent. 0.022 mmol (1.0 eq) of the vanadium precursor compound dissolved in 30 ml of hexane is then introduced into a stirrer vessel. The hexane solution is saturated for 15 minutes with propene at 1.7 bar. After shutting off the supply of propene, the overall pressure is adjusted to 3.8 bar with purified ethene. The reaction is started at 40° C. by injection of the reactivator using the pressure syringe. Stirring is carried out by means of an anchor stirrer under a constant ethene pressure at 3.8 bar and at 1000 rpm.

After 15 minutes, the reaction is terminated by the dropwise addition of the mixture into hydrochloric acid-containing methanol. The polymer precipitate is washed with ethanol and then dried for 10 hours at 50° C., and the yield is determined.

TABLE 2
Results of the ethene/propene copolymerization by vanadium-
imidoaryl catalysts.

| | | Yield | | |
|---|---|---|---|---|
| Catalyst | Tmax [° C.] | [g] | E [wt %] | P [wt %] |
| Catalyst A | 49 | 7.2 | 75.2 | 24.8 |
| Catalyst B | 51 | 8.6 | 75.4 | 24.6 |
| Catalyst C | 48 | 9.0 | 78.3 | 21.7 |
| Catalyst D | 53 | 9.3 | 72.1 | 27.9 |
| Catalyst E | 52 | 10.5 | 74.9 | 25.1 |
| Catalyst F | 48 | 10.7 | 77.1 | 22.9 |

A comparison of the test results obtained for catalysts A and D, B and E, C and F shows that vanadium-imidoaryl catalysts D, E, and F with strong electron-withdrawing groups (in this case o,o,p-Cl) at the arylring independent of the other substituents at the vanadium center shows higher polymer yields than catalysts A, B, and C described in EP-A1-0523 098 and WO-94/14854-A1.

### Example 17

Ethene/Propene Copolymerization

The apparatus adjusted to a temperature of 40° C. with a thermostat is evacuated to 5*10⁻² for 30 minutes. Purified propene is then introduced to a pressure of 1.5 bar. 40 ml of hexane, which has been rendered absolute and 0.408 mmol of the cocatalysts are introduced into the autoclave in a propene countercurrent. The apparatus is then closed under a propene atmosphere in order to fill a pressure syringe with 50 ml of hexane and 0.096 mmol (4.4 eq) of dichlorophenylacetic acid ethyl ester in a propene countercurrent. 0.022 mmol (1.0 eq) of Catalyst D dissolved in 30 ml of hexane is then introduced into a stirrer vessel. The hexane solution is saturated for 15 minutes with propene at 3.7 bar. After shutting off the supply of propene, the overall pressure is adjusted to 5.5 bar with purified ethene. The reaction is started at 40° C. by injection of the reactivator using the pressure syringe. Stirring is carried out by means of an anchor stirrer under a constant ethene pressure at 5.5 bar and at 1000 rpm.

After 15 minutes, the reaction is terminated by the dropwise addition of the mixture into hydrochloric acid-containing methanol. The polymer precipitate is washed with ethanol and then dried for 10 hours at 50° C., and the yield is determined.

TABLE 3
Results of the ethene/propene copolymerization by Catalyst D in
combination with different cocatalsts.

| | Yield |
|---|---|
| Cocatalyst | [g] |
| methylaluminoxane | 1.50 |
| diethylaluminium chloride | 6.50 |
| Ethylaluminium sequichloride | 8.40 |

The test show that vanadium-imidoaryl catalysts with strong electron-withdrawing groups (in this case o,o,p-Cl) may be activated by different cocatalysts.

### Example 18

EPDM Synthesis

An autoclave which has been rendered inert is filled with 1500 ml of hexane and 6.0 g of ethylidene norbornene and heated to the polymerization temperature of 40° C. Ethene and propene are then introduced in a ratio of 1:19 to a pressure of 7 bar. The catalyst components (0.05 mmol of V component, 1 mmol of ethylaluminum sesquichloride (Witco) and 0.25 mmol of dichlorophenylacetic acid ethyl ester) are introduced into the reactor simultaneously via pressure burettes, and polymerization is then carried out at a pressure of 7.0 bar. Regulation is effected by the metered addition of ethene. After half an hour, the test is terminated and the batch is transferred to a container filled with ethanol. The polymer is dried at 80° C. in a vacuum drying cabinet.

TABLE 4
Results of the ethene/propene/ethylidene norbornene
terpolymerization by vanadium catalysts.

| | Yield | E | P | ENB | Tg | | | |
|---|---|---|---|---|---|---|---|---|
| Catalyst | [g] | [wt. %] | [wt. %] | [wt. %] | [° C.] | M_{w} | Mₙ | M_{w}/Mₙ |
| VOCl₃ | 25.9 | 46 | 44.2 | 9.8 | −46 | 205000 | 89000 | 2.3 |
| Catalyst A | 29.4 | 44.1 | 45.8 | 10.1 | −47 | 284000 | 142000 | 2.0 |
| Catalyst B | 36.3 | 48.8 | 41.3 | 9.9 | −46 | 255000 | 140000 | 1.8 |
| Catalyst C | 34.1 | 46.6 | 44.1 | 9.3 | −48 | 254000 | 138000 | 1.8 |
| Catalyst D | 31.3 | 48.3 | 42 | 9.7 | −46 | 227000 | 117000 | 1.9 |
| Catalyst E | 45.9 | 48.4 | 42.7 | 8.9 | −47 | 254000 | 128000 | 2.0 |
| Catalyst F | 46.2 | 48.1 | 43 | 9 | −48 | 239000 | 115500 | 2.1 |
| Catalyst G | 33.9 | 46.9 | 42.8 | 10.3 | −45 | 227000 | 110000 | 2.1 |

The tests show that the vanadium-imidoaryl catalysts D, E, F, and G having strongly electron-withdrawing groups (in this case o,o,p-Cl and o,o,p-Br) are markedly more productive than catalysts according to EP-A2-0518 415 and VOCl₃ representing the prior art.

The comparisons of catalysts A with D, B with E, and C with F show that vanadium-imidoaryl catalysts with strong electron-withdrawing groups at the aryl (in this case o,o,p-Cl) independent of the structure of the other substituents at the vanadium center yield more EPDM than catalysts A, B and C which represent the prior art described in EP-A1-0523 098 and WO-94/14854-A1.

### Example 19

Synthesis of (2,4,6-I₃Ph)-N═VCl₃—Catalyst H

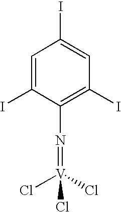

To 23.54 g 2,4,6-Triiodoaniline (0.05 mol) dissolved in 20 ml benzene 11.9 g thionylchloride (0.1 mol) are added at 25° C. The reaction mixture is refluxed for 6 h. All volatile constituents are removed at 40° C./10-2 mbar. Upon cooling to room temperature the orange-red 2,4,6-triiodophenylsulfinylamine solidifies.

C: 14.83 (calc. 14.39); H: 0.61 (calc. 0.40); N: 2.75 (calc. 2.80)

EI-MS: m/z=517 (M⁺).

The 2,4,6-triiodophenylsulfinylamine is used without further purification. 0.86 ml (9.06 mmol) VOCl₃ dissolved 20 ml toluene are added dropwise to 4.66 g (9.02 mmol) of the 2,4,6-triiodophenylsulfinylamine 20 ml toluene. The reaction mixture turns dark green after a few minutes. After 60 minutes of stirring, volatile constituents are removed in vacuum. The residue is dissolved in 80 ml of n-pentane and stored at −78° C. over night. The product precipitates, is filtered off and dried in vacuum.

Yield: 4.40 g (78%)

C: 11.44 (calc. 11.51); H: 0.62 (calc. 0.32); N: 2.25 (calc. 2.24)

¹H-NMR: (200 MHz, C₆D₆): 7.50 (s, 2H, Ar—H) ppm.

### Example 20 (Comparative Example):

Synthesis of (2,4,6-Br₃Ph)-N═V(NtBuCH₂H₂NtBu)Cl—Catalyst I

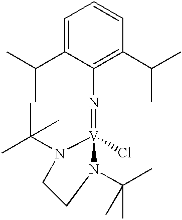

[(Li(THF₂)₂)(tBuNC₂H₂NtBu)] is prepared as specified in the literature (H. Görls, B. Neumüller, A. Scholz, J. Scholz, Angew. Chem. Vol. 107 (1995), 732-735 according to page 704, foot note 6b). (2,6-iPr₂Ph)-N═VCl₃ is prepared as described in Example 1).

601 mg (1.81 mmol) (2,6-iPr₂Ph)-N═VCl₃ and 583 mg (1.24 mmol) [(Li(THF₂)₂)(tBuNC₂H₂NtBu)] are dissolved in 20 ml of diethylether each and the two solutions are combined at −30° C. The mixture is stirred at room temperature for 1 h after which insoluble byproducts are filtered off. Volatile constituents are removed from the filtrate in vacuum and the product is dissolved in n-pentane. At −78° C. the oily product separates from pentane.

Yield: 368 mg (51%)

¹H-NMR: (200 MHz, CDCl₃): 1,18 (s, 18H, CH₃),1,22 (d, 12H, CH₃), 2,86 (sep, 2H, sp³-CH), 6,73 (t, 2H, Ar—H),6,97 (d, 1H, Ar—H),7,87 (s, 2H, sp²-CH) ppm

IR-Spectrum (in Nujol): 3407 w, 2959 vs, 2926 vs, 2857 vs, 2361 w, 2344 w, 1630 m, 1422 w, 1364 m, 1339 m, 1290 w, 1262 s, 1215 m, 1098 s, 1022 s, 990 w, 934 w, 866 w, 806 s, 770 m, 752 m, 729 w, 669 w, 432 vs, 413 vs.

### Example 21

Synthesis of (2,4,6-Cl₃Ph)-N═V(NtBuCH₂CH₂NtBu)Cl—Catalyst K

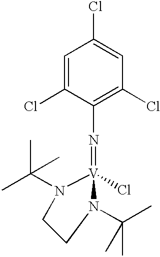

[(Li(THF₂)₂)(tBuNC₂H₂NtBu)] is prepared as described in Example 20 (2,4,6-Cl₃Ph)-N═VCl₃ is prepared as described in Example 11.

300 mg (0.85 mmol) (2,4,6-Cl₃Ph)-N═VCl₃ and 400 mg (0.85 mmol) [(Li(THF)₂)₂(tBuNC₂H₂NtBu)] are dissolved in 20 ml of diethylether each. The two solutions are combined at −50° C. and stirred until room temperature is reached. Byproducts are filtered of and volatile constituents are removed in vacuum. The obtained red-brown oil is digested two times with 20 ml n-pentane each. Insoluble portions are filtered off. The dark-brown product separates at −78° C. from the filtrate and is concentrated to dryness in order to obtain the product.

Yield: 200 mg (52%)

¹H-NMR: (200 MHz, CDCl₃):1,19 (s, 18H, CH₃), 7,13 (d, 2H, Ar—H), 7,87 (s, 2H, sp²-CH) ppm.

¹³C-NMR: (50 MHz, CDCl₃): 28,38 (CH₃), 30,02 (CH₃), 57,18 (sp²C),126,59 (Ar),156,90 (Ar—Cl) ppm

IR-Spektrum (in Nujol): 3402 w, 2901 vs, 2724 w, 2361 w, 2344 w, 1630 m, 1559 w, 1298 m, 1262 m, 1211 w, 1098 m, 1022 m, 934 w, 858 m, 802 m, 723 m, 669 w, 428 vs, 401 vs

### Example 22

Synthesis of (2,4,6-Br₃Ph)-N═V(NtBuCH₂CH₂NtBu)Cl—Catalyst L

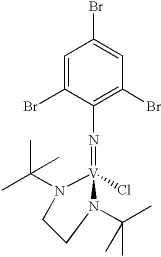

[(Li(THF₂)₂)(tBuNC₂H₂NtBu)] is prepared as described Example 20. (2,4,6-Br₃Ph)-N═VCl₃ is prepared as described in example 14.

A mixture of 601 mg (1.24 mmol) (2,4,6-Br₃Ph)-N═VCl₃ and 583 mg (1.24 mmol) [(Li(THF₂)₂)(tBUNC₂H₂NtBu)] is treated at −30° C. with 30 ml diethylether. The orange-brown solution is warmed to room temperature. After removal of volatile constituents in vacuum a red-brown oil is obtained. The oil is extracted with n-pentane and stored at −78° C. yielding the product in form of a dark brown oil.

Yield: 368 mg (51%)

C: 32.06 (calc. 32.99); H: 3.62 (calc. 3.81); N: 7.00 (calc. 7.26)

¹H-NMR: (200 MHz, CDCl₃): 1,21 (s, 18H, CH₃), 7,12; (s, 2H, Ar—H), 8,01 (s, 2H, sp²-CH)

¹³C-NMR: (50 MHz, CDCl₃): 31,28 (sp³-C),159,61 (Ar-Br) ppm

IR-Spectrum (in Nujol) 2928 vs, 2724 w, 2361 w, 2344 w, 1632 s, 1362 s, 1337 w, 1260 m, 1213 s, 1098 m, 1026 m, 934 w, 878 w, 858 w, 806 m, 774 m, 747 m

### Example 23

Synthesis of (2,4,6-Cl₃Ph)-N═V[CHMe(3,5-tBu₂Ph—O)₂]Cl—Catalyst M

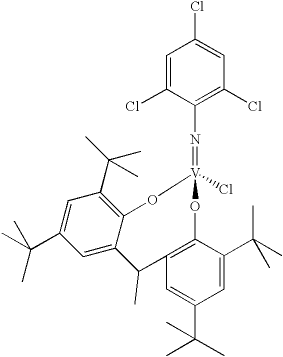

(2,4,6-Cl₃Ph)-N═VCl₃ is prepared as described in example 11.

At −30° C. a solution of 1.00 g (2.27 mmol) 1,1-Bis(3,5-di-tert-butyl-2-hydroxyphenyl)ethane in 40 ml n-hexane is added to a solution of 0.80 g (2.27 mmol) (2,4,6-Cl₃Ph)-N═VCl₃ in 40 ml n-hexane, which spontaneously turns violet. The reaction mixture is stirred for 18 h. After removal of volatile constituents in vacuum the residue is washed with n-pentane and finally dried in vacuum.

Yield: 1.38 g (85%)

¹H-NMR: (300 MHz, CDCl₃): 1.30 (s, 18H, C(CH₃)₃), 1.44 (s, 18H, C(CH₃)₃), 1.75 (d, 3H, CH₃, ³J(HH)=6.84 Hz), 4.85 (q, ³J(HH)=6.87 Hz, 1H, CH—CH₃), 7.08-7.38(m 6H, Ar—H) ppm

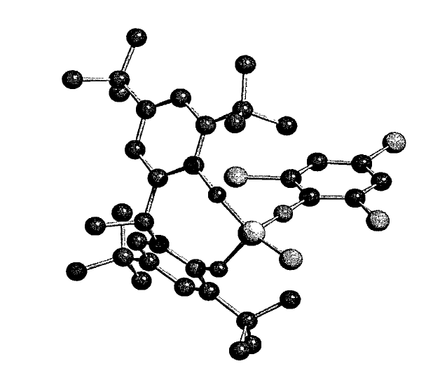

Storing a saturated solution of the product in n-pentane at −30° C. for several days yields single crystals suitable for x-ray diffraction. (FIG. 1)

### Example 24

Synthesis of (2,4,6-Cl₃Ph)-N═V[CH₂(2-tBu,4-Me—Ph—O)₂]Cl—Catalyst N

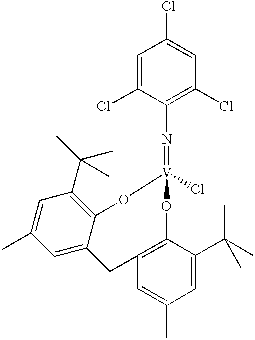

(2,4,6-Cl₃Ph)-N═VCl₃ is prepared as described in example 11.

At room temperature a solution of 0.70 g (2.07 mmol) 2,2-methylenbis(6-tert-butyl-4-methyl-phenol) in 50 ml of toluene is added to a solution of 0.72 g (2.05 mmol) (2,4,6-Cl₃Ph)-N═VCl₃ in 50 ml toluene. The mixture spontaneously turns violet. The reaction mixture is stirred for 18 h. After removal of volatile constituents in vacuum the product is dissolved in n-pentane and byproducts are filtered off. The filtrate is stored at −30° C. to crystallize the product.

Yield: 1.04 g (82%)

¹H-NMR: (200 MHz, CDCl₃): 1,37 (s, 18H, C(CH₃)₃, 2.23 (s, 6H, CH₃), 4,59(m, 2H, CH₂), 7.17(m 6H, Ar—H) ppm

IR-Spectrum (in Nujol): 3400 w, 3350 m, 3179 w, 2930 s, 2870 s, 2729 m, 2683 w, 2376 m, 2340 w, 2050 m, 2026 w, 1623 w, 1590 s, 1540 w, 1518 w, 1302 m, 1281 w, 1268 m, 1219 m, 1170 w, 1165 w, 1100 m, 1075 w, 1024 w, 1000 m, 978 w, 930 w, 909 m, 891 w, 870 m, 851 w, 833 1, 800 m, 776 m, 760 w, 721 s, 678 w, 660 m, 423 m, 412 m.

### Example 25

Synthesis of (2,4,6-Cl₃Ph)-N═V[CH₂(2-tBu,4-Me-Ph-O)₂]Cl—Catalyst O

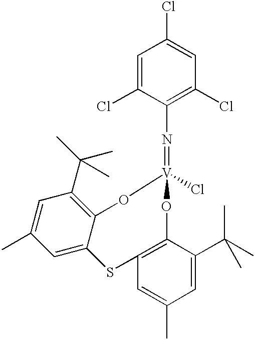

(2,4,6-Cl₃Ph)-N═VCl₃ is prepared as described in example 11.

0.51 g (1.45 mmol) (2,4,6-Cl₃Ph)-N═VCl₃ and 0.50 g 3-tert.-butyl-2-hydroxy-5-methylphenylsulfide (1.45 mmol) are treated at room temperature with 60 ml of toluene. The reaction mixture is stirred for 18 h. After removal of volatile constituents in vacuum the red residue is washed with n-pentane and finally dried in vacuum.

Yield: 0.72 g (78%)

¹H-NMR: (300 MHz, CDCl₃): 1.30 (s, 18H, C(CH₃)₃), 2.25 (s, 6H, CH₃), 716 (m 6H, Ar—H) ppm

### Example 26

### Ethene/Propene Copolymerization

The apparatus adjusted to a temperature of 40° C. with a thermostat is evacuated to 5*10⁻² for 30 minutes. Purified propene is then introduced to a pressure of 1.5 bar. 40 ml of hexane, which has been rendered absolute and 0.408 mmol of the cocatalysts are introduced into the autoclave in a propene countercurrent. The apparatus is then closed under a propene atmosphere in order to fill a pressure syringe with 50 ml of hexane and 0.096 mmol (4.4 eq) of dichlorophenylacetic acid ethyl ester in a propene countercurrent. 0.022 mmol (1.0 eq) of the vanadium precursor compound dissolved in 30 ml of hexane is then introduced into a stirrer vessel. The hexane solution is saturated for 15 minutes with propene at 4.0 bar. After shutting off the supply of propene, the overall pressure is adjusted to 5.8 bar with purified ethene. The reaction is started at 40° C. by injection of the reactivator using the pressure syringe. Stirring is carried out by means of an anchor stirrer under a constant ethene pressure at 5.8 bar and at 1000 rpm.

After 15 minutes, the reaction is terminated by the dropwise addition of the mixture into hydrochloric acid-containing methanol. The polymer precipitate is washed with ethanol and then dried for 10 hours at 50° C., and the yield is determined.

TABLE 7
Results of the ethene/propene copolymerization by vanadium
imidoaryl catalysts.

| | | Yield | | |
|---|---|---|---|---|
| Catalyst | Tmax. [° C.] | [g] | E [wt %] | P [wt %] |
| VOCl₃ | 57.3 | 5.1 | 59.9 | 40.1 |
| Catalyst D | 64.2 | 8.2 | 64.1 | 35.9 |
| Catalyst G | 61.7 | 9.6 | | |
| Catalyst H | 64.8 | 6.0 | | |
| Catalyst I | 59.5 | 8.4 | 63.4 | 36.6 |
| Catalyst K | 63.1 | 9.2 | 64.0 | 36.0 |
| Catalyst L | 61.8 | 8.5 | 65.0 | 35.0 |
| Catalyst M | 64.4 | 8.6 | 63.0 | 37.0 |
| Catalyst N | 59.5 | 6.5 | 62.8 | 37.2 |
| Catalyst O | 62.4 | 6.2 | 61.9 | 38.1 |

The results of the test show that catalysts according to the invention which contain in addition to the imido-group a chelating ligand at the vanadium center (catalysts K,L,M,N,O) can be used for ethene/propene copolymerization. They are more productive than the prior art VOCl₃ catalyst and as shown by comparison of the results for catalysts K and L with those for catalyst I also more productive than vanadium-imidoaryl catalysts without electron-withdrawing substituents.

The tests show that vanadium-imidoaryl catalysts having strongly electron-withdrawing groups (in this case o,o,p-Cl) are markedly more productive and yield copolymers having higher molecular weights and a narrower molecular weight distribution than catalysts based on VOCl₃, such as represent the prior art.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A vanadium-imidoaryl compound comprising electron-withdrawing substituents at an aryl group.

2. The compound according to claim 1 having a general formula of R—N═VCl₃ (I) or R—N═VXYZ (II),
wherein R represents an aryl group carrying one or more electron-withdrawing substituents,
wherein X,Y,Z are each independently different or identical monoanionic ligands which may be bonded to one another and/or to the aryl group of the imide, or its substituents.

3. The compound according to claim 1 having one of the following structures 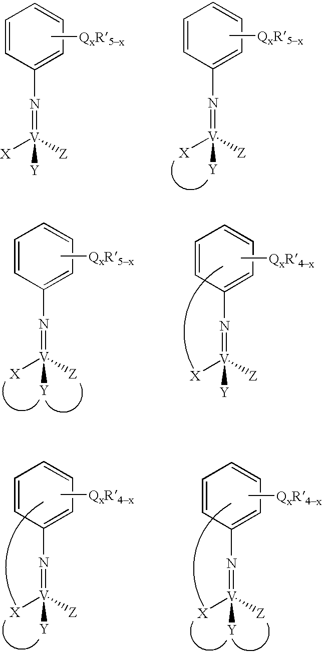
wherein Q represents the electron-withdrawing group(s) and R′ represents additional substituents of the aryl group, which are selected from the group consisting of hydrogen, halogen, nitro, C₁-C₁₀-alkoxy, C₁-C₁₀-alkyl, C₆-C₁₄-cycloalkyl and C₆-C₁₄-aryl.

4. The compound according to any one of claim 1, wherein the electron-withdrawing substituents is one or more compounds selected from the group consisting of halogen, halogenated alkyl, nitro, cyano, carbonyl and carboxyl groups.

5. A composition comprising vanadium-imidoaryl compounds having electron-withdrawing substituents at an aryl group, and an organometallic compound of Groups 1, 2, 12 or 13 of the periodic system of elements, wherein at least one hydrocarbon group in the organometallic compound is bonded directly to a metal atom via a carbon atom.

6. A compositions according to claim 5, wherein the vanadium-imidoaryl compound comprises electron-withdrawing substituents at an aryl group.and wherein the organometallic compound is aluminium, sodium, lithium, zinc or magnesium.

7. A catalyst comprising vanadium-imidoaryl compounds having electron-withdrawing substituents at an aryl group, and an organometallic compound of Groups 1, 2, 12 or 13 of the periodic system of elements, wherein at least one hydrocarbon group in the organometallic compound is bonded directly to a metal atom via a carbon atom.

8. A catalyst for the polymerization of olefins comprising vanadium-imidoaryl compounds having electron-withdrawing substituents at an aryl group, and an organometallic compound of groups 1, 2, 12 or 13 of the periodic system of elements, wherein at least one hydrocarbon group in the organometallic compound is bonded directly to a metal atom via a carbon atom.

9. A catalyst according to claim 8, further comprising a compound selected from the group consisting of halogen-containing compounds, halogen-containing hydrocarbons, Lewis acids or Lewis bases and mixtures thereof.

10. A process for the homo- or co-polymerization an olefin, comprising the step of polymerizing the olefin in the presence of a catalyst comprising vanadium-imidoaryl compounds having electron-withdrawing substituents at an aryl group, and an organometallic compound of Groups 1, 2, 12 or 13 of the periodic system of elements, wherein at least one hydrocarbon group in the organometallic compound is bonded directly to a metal atom via a carbon atom,optionally with one or more diene.

11. A process for the homo- or co-polymerization of an olefin, comprising the step of polymerizing the olefin in the presence of a vanadium-imidoaryl compound comprising electron-withdrawing substituents at an aryl group, optionally with one or more dienes.

12. A process for the homo- or co-polymerization of an olefin, comprising the step of polymerizing the olefin in the presence of a composition comprising vanadium-imidoaryl compounds having electron-withdrawing substituents at an aryl group, and an organometallic compound of Groups 1, 2, 12 or 13 of the periodic system of elements, wherein at least one hydrocarbon group in the organometallic compound is bonded directly to a metal atom via a carbon atom, optionally with one or more dienes.
